(19) United States
(12) Patent Application Publication
(10) Pub. No.: US 2025/0179853 A1
(43) Pub. Date: Jun. 5, 2025

(54) FITTING

(71) Applicant: Julius Blum GmbH, Hoechst (AT)

(72) Inventor: Tobias HEIDER, Dornbirn (AT)

(21) Appl. No.: 19/049,593

(22) Filed: Feb. 10, 2025

Related U.S. Application Data
(63) Continuation of application No. PCT/AT2023/060293, filed on Aug. 30, 2023.

(30) Foreign Application Priority Data
Sep. 9, 2022 (AT) A 50685/2022

(51) Int. Cl. E05F 5/00

(52) U.S. Cl. CPC E05F 5/006; E05Y 2201/21; E05Y 2900/20

(57) ABSTRACT

A fitting includes at least two fitting portions movable relative to each other, and a damping device dampens a relative movement of the two fitting portions to each other. The damping device is supported on and/or in one of the two fitting portions, and includes a damper housing, a piston displaceable in the damper housing, and a piston rod connected to the piston. An actuator can move the piston rod of the damping device into the damper housing during a damping stroke, and an arresting device limits or deactivates a damping power of the damping device. The arresting device can arrest the actuator relative to the fitting portion supporting the damping device, and at least one of the fitting portions includes a hinge cup. The damper housing is mounted outside and below a fastening flange of the hinge cup, and the actuator is linearly displaceably supported on the hinge cup.

The present application is a continuation of International Application PCT/AT2023/060293, filed on Aug. 30, 2023. Thus, all of the subject matter of International Application PCT/AT2023/060293 is incorporated herein by reference.

### BACKGROUND OF THE INVENTION

The present invention relates to a fitting configured as a furniture fitting or as a construction fitting, the fitting comprising at least two fitting portions movable relative to each other, and at least one damping device for dampening a relative movement of the two fitting portions to each other, the damping device being supported on and/or in one of the two fitting portions, the damping device including at least one damper housing, at least one piston displaceable in the damper housing, and a piston rod connected to the piston. At least one actuator is configured to move the piston rod of the damping device into the damper housing when a damping stroke is performed, and at least one arresting device can limit or deactivate a damping power of the damping device, with the arresting device being configured to arrest the at least one actuator relative to that fitting portion on which and/or in which the damping device is supported. At least one of the two fitting portions includes a hinge cup, and the damper housing is arranged on an outside of the hinge cup and below a fastening flange of the hinge cup in a mounted position.

Moreover, the invention concerns an item of furniture comprising at least one fitting of the type to be described.

WO 2012/024702 A1 discloses a damping device for movable furniture parts, in which the damping device is configured to be arranged within an inner cavity of a hinge cup of a furniture hinge. By an arresting element in the form of an adjustable switch, the damping function of the damping device can be deactivated. The deactivation of the damping function is particularly advantageous when the movable furniture part is pivotally arranged on a furniture carcass via two or more furniture hinges, and the damping function of the furniture hinges can be selectively activated or deactivated so as to adapt the closing speed of the movable furniture part. A drawback of this construction is the fact that the piston rod of the damping device is stationarily arranged, and that the damper housing is moved relative to the stationary piston rod upon each damping stroke. The support of the movable damper housing is namely relatively instable and is connected with several challenges from a constructional point of view.

Furniture hinges with a damping device in the form of a linear damper and with an arresting device for limiting or for deactivating a damping power of the damping device are disclosed, for example, in WO 2013/029068 A1, WO 2022/157071 A1, WO 2015/155579 A1, WO 2020/169300 A1 and WO 2011/026465 A1. A drawback of these constructions is the fact that the constructional unit of the arresting device is relatively large and that the furniture hinge is not suitable for specific applications.

### SUMMARY OF THE INVENTION

It is an object of the present invention to propose a fitting of the type mentioned in the introductory part, thereby avoiding the above-discussed drawbacks. According to the invention, the actuator is linearly displaceably supported on the hinge cup. In this way, the fitting can be designed in a more compact manner.

For pressurizing the piston rod, an actuator is provided, the actuator being arrestable by an arresting device with respect to that fitting portion on which and/or in which the damping device is supported.

This has the advantage that the damper housing can be stationarily arranged and thus more stable on one of the fitting portions. By the arresting device, a position of the piston rod displaceable relative to the damper housing is arrestable via a movable actuator. Depending on the position of the piston rod relative to the damper housing, the damping function of the damping device can be limited or can be substantially deactivated, because the piston rod can only perform a reduced residual stroke, or substantially no residual stroke at all.

### BRIEF DESCRIPTION OF THE DRAWINGS

Further details and advantages of the present invention will be apparent from the following description of figures, in which:

FIG. 1 is a perspective view of an item of furniture comprising a furniture carcass and a furniture part movably-supported relative to the furniture carcass via fittings,

FIG. 2a, 2b show an embodiment of a fitting in two different perspective views,

FIG. 3a-3d are two cross-sectional views and enlarged detail views of the second fitting portion, in which a coupling element of the actuator is located in a decoupled position and in a coupled position with respect to the arresting device,

FIG. 4 shows the fitting in an exploded view,

FIG. 5a, 5b show a fitting according to a second embodiment, in which the damping device and the arresting device are arranged above each other on a same side of a fitting portion,

FIG. 6a, 6b show the fitting according to FIGS. 5a, 5b in a cross-sectional view and in a detail view, and

FIG. 7 shows the fitting according to FIGS. 5a, 5b, 6a, 6b in an exploded view.

### DETAILED DESCRIPTION OF THE INVENTION

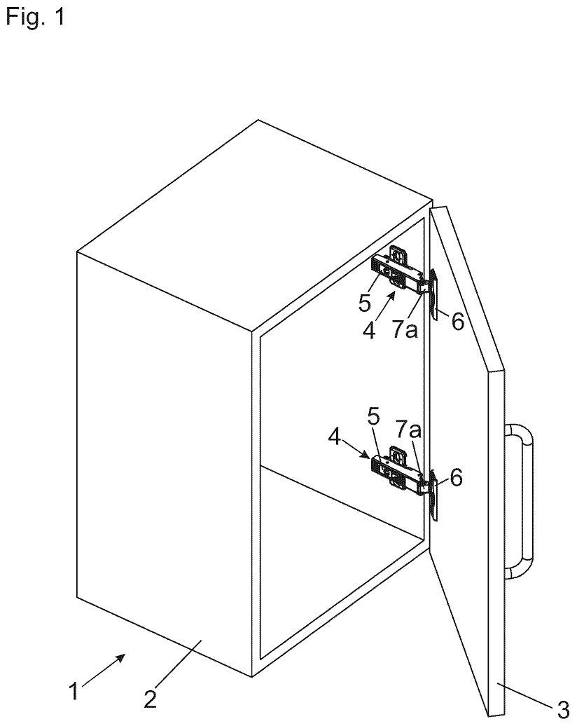

FIG. 1 shows a perspective view of an item of furniture 1 comprising a furniture carcass 2 and a movable furniture part 3, the furniture part 3 being movably-supported relative to the furniture carcass 2 via fittings 4.

The fittings 4 include a first fitting portion 5 configured to be fixed to the furniture carcass 2, and a second fitting portion 6 configured to be fixed to the movable furniture part 3. The two fitting portions 5, 6 are pivotally supported relative to each other.

In the shown embodiment, the two fitting portions 5, 6 are connected to each other via at least one hinge lever 7a, preferably via precisely two hinge levers 7a, 7b. The second hinge lever 7b cannot be seen in FIG. 1.

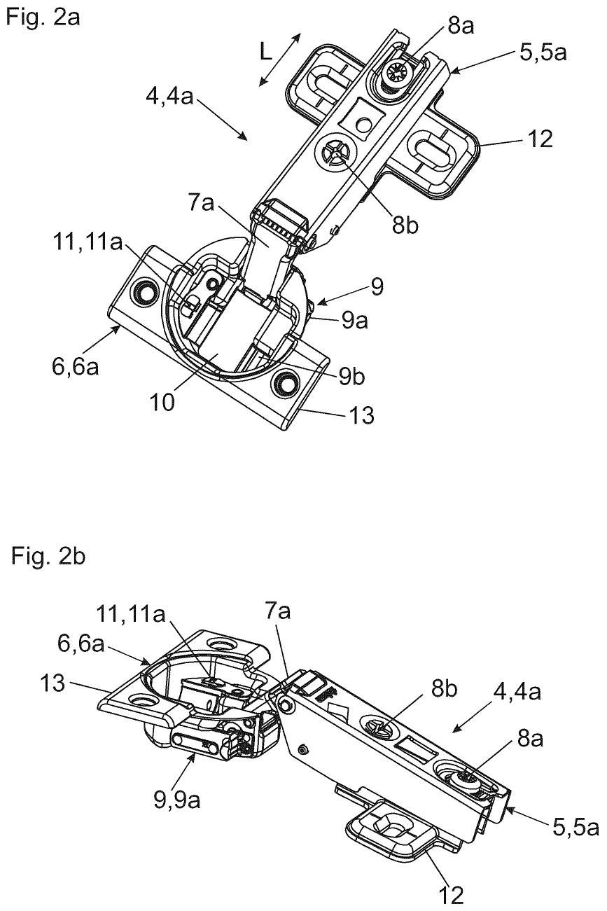

FIG. 2a shows an embodiment of a fitting 4 in the form of a furniture hinge 4a in a perspective view. The two fitting portions 5, 6 are pivotally connected to each other via at least one hinge lever 7a.

At least one of the two fitting portions 5, 6 includes a hinge cup 6a.

However, it is also possible that both fitting portions 5, 6 include a hinge cup 6a. Such fittings are already known and are used, in particular, for hingedly connecting two panel-shaped furniture parts which are each movably-supported relative to a furniture carcass.

The first fitting portion 5 is releasably lockable to a base plate 12 to be fixed to the furniture carcass 2. In a first step, the base plate 12 is to be fixed to the furniture carcass 2. In a subsequent step, the first fitting portion 5 can be mounted to the base plate 12 without the use of a tool. If required, the first fitting portion 5 can be again separated from the base plate 12 without the use of a tool.

By at least one adjustment device 8a, 8b, a position of the first fitting portion 5 relative to the base plate 12 is adjustable.

In the shown embodiment, two adjustment devices 8a, 8b are provided. By the first adjustment device 8a, a position of the first fitting portion 5 is adjustable in a longitudinal direction L of the base plate 12. By the second adjustment device 8b, an inclination of the first fitting portion 5 relative to the base plate 12 is adjustable.

By a damping device 9, a relative movement of the two fitting portions 5, 6 to each other can be dampened. The damping device 9 is configured as a linear damper and includes a damper housing 9a and a piston rod 9b movable relative to the damper housing 9a. The piston rod 9b, in an extended position relative to the damper housing 9a, projects partially into an inner cavity of the hinge cup 6a.

The damper housing 9a is arranged on an outside of the hinge cup 6a and is arranged below a fastening flange 13 of the hinge cup 6a in a mounted position.

According to a preferred embodiment, the hinge cup 6a, jointly with the damper housing 9a arranged on the outside of the hinge cup 6a, is configured to be arranged within a bore typically used in furniture manufacture, for example within a bore having a diameter of 35 mm.

By a movably-supported, preferably linearly displaceable, actuator 10, the piston rod 9b can be pushed into the damper housing 9a. The actuator 10 is coupled to a relative movement of the two fitting portions 5, 6, and the actuator 10 can be pressurized by the hinge lever 7a at the end of the closing movement of the fitting 4, thereby being movable relative to the second fitting portion 6.

By this movement of the actuator 10, the piston rod 9b can be pushed into the damper housing 9a, and the closing movement of the two fitting portions 5, 6 relative to each other can be dampened due to a relative movement between the piston rod 9b and the damping housing 9a and due to the resistance of a, preferably hydraulic, damping fluid arranged in the damper housing 9a.

In the shown embodiment, an arresting device 11 with a movable switch 11a is arranged in or on the second fitting portion 6a, preferably on or in the hinge cup 6a.

By the arresting device 11, a position of the piston rod 9b is arrestable relative to that fitting portion 5, 6 in which or on which the damping device 9 is supported. In the present case, a position of the piston rod 9b relative to the second fitting portion 6 is arrestable by the arresting device 11.

The switch 11a of the arresting device 11 is movably supported between at least two switching positions in a direction extending transversely to the longitudinal direction of the piston rod 9b. In the first switching position of the switch 11a, a damping function of the damping device 9 is activated. In a second switching position of the switch 11a, the damping function of the damping device 9 is limited or deactivated.

Alternatively, it is possible that the switch 11a is pivotally supported between two or more switching positions.

FIG. 2b shows the fitting 4 according to FIG. 2a in a further perspective view. In the shown embodiment, the damper housing 9a is arranged on a first side of the hinge cup 6a, and the arresting device 11 with the switch 11a is arranged on a second side of the hinge cup 6a, the second side of the hinge cup 6a opposing the first side.

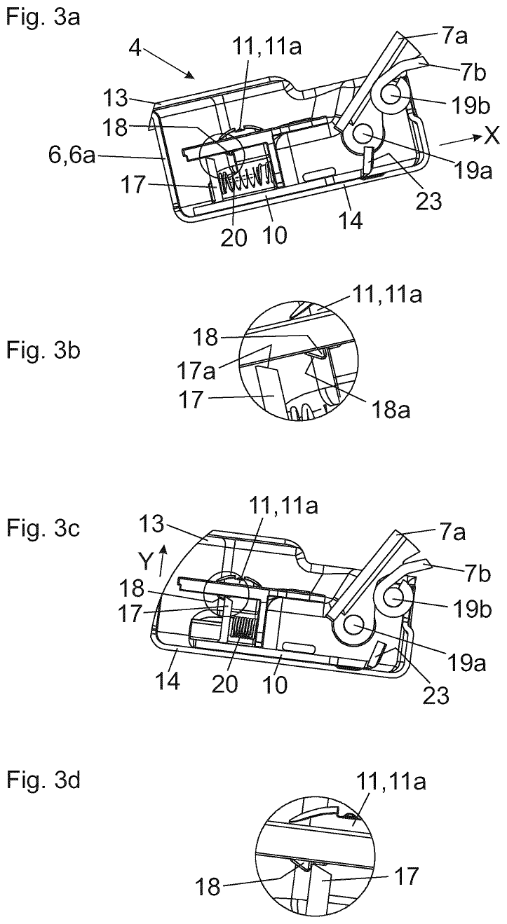

FIG. 3a shows a cross-sectional view of the second fitting portion 6 in the form of the hinge cup 6a. The second fitting portion 6 is connected to the first fitting portion 5 via two hinge levers 7a, 7b. The first hinge lever 7a is connected to the second fitting portion 6 via a hinge axis 19a, and the second hinge lever 7b is connected to the second fitting portion 6 via a hinge axis 19b.

To be seen is a bearing surface 23 arranged on the actuator 10, the bearing surface 23 being configured to be coupled to the hinge lever 7a upon a closing movement of the fitting 4. In this way, a pivotal movement of the hinge lever 7a is converted into a linear movement of the actuator 10 in a direction X of the damping stroke.

For limiting or for deactivating the damping power of the damping device 9, the switch 11a of the arresting device 11 is initially to be moved into a corresponding switching position. Upon a closing movement of the fitting 4, the first hinge lever 7a is moved about the first hinge axis 19a. This movement of the first hinge lever 7a is converted, via the bearing surface 23, into a movement of the actuator 10 in the direction X. Thereby, also a coupling element 17 of the actuator 10 is moved against a force of a spring element 20 in the direction X, the coupling element 17 being configured to be coupled to the arresting device 11.

Preferably, the actuator 10, the bearing surface 23 and the coupling element 17 are formed together so as to have an integral one-piece configuration.

A coupling element 18 is arranged on the switch 11a of the arresting device 11, and the coupling element 17 of the actuator 10 is arrestable by the coupling element 18. In FIG. 3a, the uncoupled condition between the two coupling elements 17, 18 is illustrated.

FIG. 3b shows the encircled region of FIG. 3a in an enlarged view. The coupling element 17 of the actuator 10 includes a first inclined surface 17a configured to co-operate with a second inclined surface 18a of the coupling element 18, the coupling element 18 being connected to the switch 11a.

FIG. 3c shows the coupling element 17 of the actuator 10, the coupling element 17 being fixed by the arresting device 11. Due to the co-operation of the two inclined surfaces 17a, 18a, the switch 11a has slightly been lifted in the direction Y, so that the coupling element 17 of the actuator 10 is further movable in the direction X, against a force of the spring element 20, past the coupling element 18 of the switch 11a. After the coupling element 17 of the actuator 10 has passed the coupling element 18 of the switch 11a, the coupling element 18 of the switch 11a snaps into a position so as to hold the coupling element 17.

FIG. 3d shows the encircled region of FIG. 3c in an enlarged view. The coupling element 17 of the actuator 10 cannot be extended by a force of the loaded spring element 20, because the coupling element 18a of the switch 11a blocks a movement of the actuator 10.

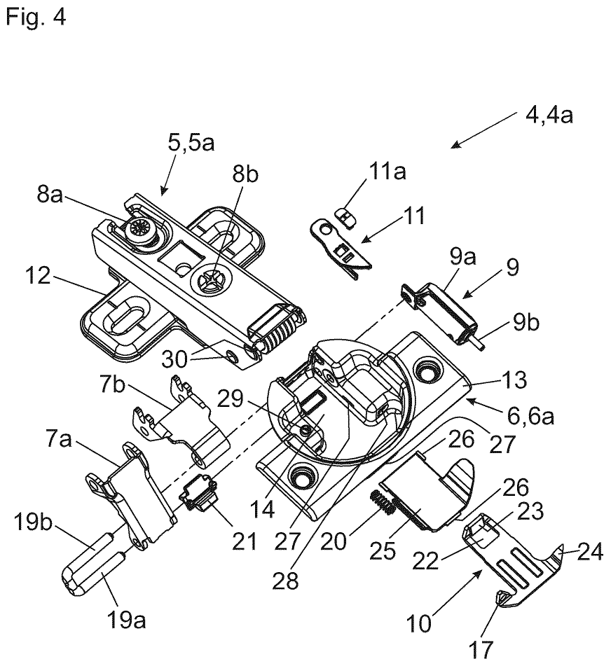

At the same time, the piston rod 9b is thereby held in a retracted position relative to the damper housing 9a, preferably via a limb 24 (FIG. 4) of the actuator 10, and cannot be moved out from the damper housing 9a. As a result, a damping power of the damping device 9 is limited or substantially deactivated.

For releasing the coupling element 17, the switch 11a is movable into a position in which the coupling element 17 is unblocked. After unblocking, the coupling element 17 and thus the actuator 10 can be again returned by a force of the spring element 20.

The switch 11a can be configured for manual actuation. However, it is also possible that the switch 11a includes a receiving contour for a tool.

FIG. 4 shows the fitting 4 in the form of the furniture fitting 4a in an exploded view.

According to possible embodiments:
the actuator 10 is substantially entirely arranged within the hinge cup 6a, and/or
the actuator 10 is movably-supported relative to the hinge cup 6a, and/or
the actuator 10 is arranged substantially parallel or perpendicular to a bottom 14 of the hinge cup 6a, and/or
the damper housing 9a is entirely arranged outside the hinge cup 6a, and/or
the piston rod 9b partially projects into the hinge cup 6a, and/or
the hinge cup 6a includes a hole 28 for the passage of the piston rod 9b, and/or
the damper housing 9a is arranged on a first side of the hinge cup 6a and the arresting device 11 is arranged on a second side of the hinge cup 6a, the second side of the hinge cup 6a opposing the first side, or that the damper housing 9a and the arresting device 11 are arranged on a same side of the hinge cup 6a above each other, and/or
the arresting device 11 is firmly connected to the hinge cup 6a, preferably via at least one rivet 29.

In the shown embodiment, the fitting portions 5, 6 are pivotally connected to each other via at least one hinge lever 7a, 7b. Preferably:
the at least one actuator 10 can be pressurized by the at least one hinge lever 7a, 7b, and/or
the at least one actuator 10 can be pressurized only upon a closing movement of the at least one hinge lever 7a, 7b, and/or
the at least one actuator 10 includes a recess 22 in which the at least one hinge lever 7a, 7b or a coupling device 21 connected to the hinge lever 7a, 7b engages upon a closing movement of the fitting 4, and/or
at least one coupling device 21 is provided, the coupling device 21 converting a pivotal movement of the at least one hinge lever 7a, 7b into a linear movement of the at least one actuator 10, and/or
the at least one hinge lever 7a, 7b is connected to the first fitting portion 5 via a hinge axis 30, and is connected to the second fitting portion 6 via a further hinge axis 19a, 19b.

The actuator 10 includes a bearing surface 23 for contacting the coupling device 21, the coupling device 21 and the bearing surface 23 being motionally coupled to each other upon a closing movement of the fitting 4. The coupling device 21 can be configured as a plastic member or as a metal member. Alternatively, the coupling device 21 and one of the hinge levers 7a, 7b are formed together so as to have an integral one-piece configuration.

According to possible embodiments, the actuator 10:
is substantially T-shaped or substantially L-shaped, and/or
includes at least one coupling element 17 configured to be releasably coupled to the arresting device 11, and/or
includes a, preferably laterally protruding, limb 24 configured to bear, preferably loosely, against a free end of the piston rod 9b, and/or
is movable relative to a gliding element 25, the gliding element 25 being arranged between one of the fitting portions 5, 6 and the actuator 10 so as to reduce friction.

The gliding element 25 for reducing a gliding friction of the actuator 10 can include at least one protrusion 26, preferably a plurality of protrusions 26, engaging into an opening 27 of the second fitting portion 6 in a mounted condition of the gliding element 25.

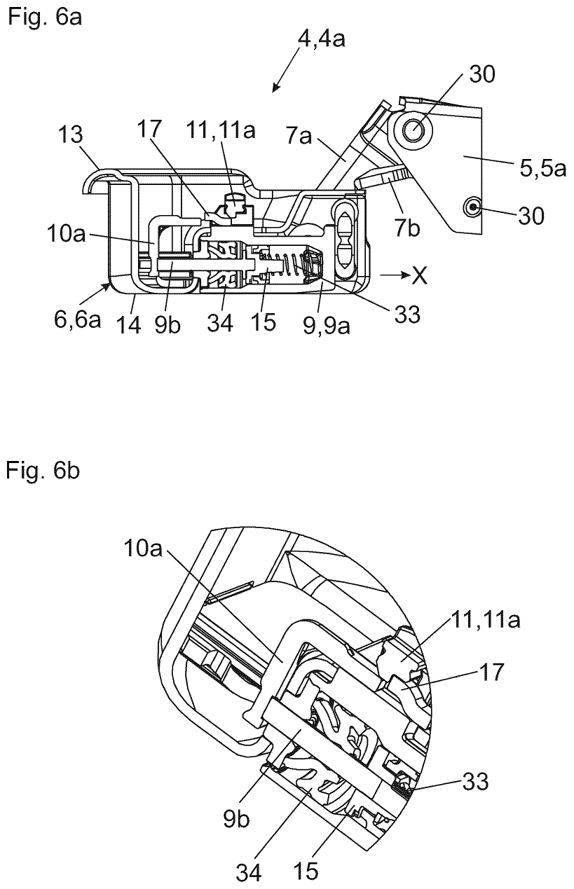

At least one spring element 20, preferably a compression spring, is provided for returning the at least one actuator 10. In addition or as an alternative, the damping device 9 includes a return spring 33 (FIG. 6a, 6b) for partially returning the piston rod 9b and the actuator 10.

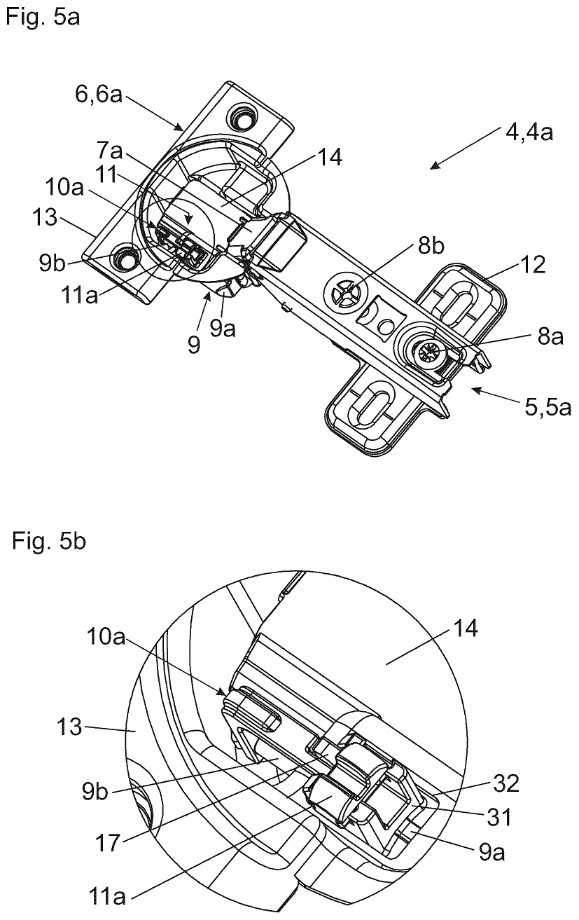

FIG. 5a shows a fitting 4 in the form of a furniture hinge 4a according to a second embodiment, in which the damping device 9 and the arresting device 11 for limiting or for deactivating the damping power are arranged above each other on a same side of the second fitting portion 6 in the form of the hinge cup 6a.

The damper housing 9a is fixed to an outside of the hinge cup 6a. The piston rod 9b, in an extended position relative to the damper housing 9a, projects through a hole 28 (FIG. 4) of the hinge cup 6a into an interior of the hinge cup 6a.

By an arresting device 11 with a switch 11a, the damping power of the damping device 9 can be limited or deactivated. Preferably, the switch 11a is movable between at least two switching positions in a direction extending transversely to a longitudinal direction of the piston rod 9b.

FIG. 5b shows the encircled region of FIG. 5a in an enlarged view. With this embodiment, an actuator 10a is substantially L-shaped and extends partially in a direction extending substantially perpendicular to the bottom 14 of the hinge cup 6a.

A bearing device 31 is provided for movably supporting the actuator 10a and/or for movably supporting the switch 11a. The bearing device 31 is connected to the damper housing 9a and projects through an opening 32 of the second fitting portion 6, preferably of the hinge cup 6a.

According to a preferred embodiment, the bearing device 31 and the damper housing 9a are formed together so as to have an integral one-piece configuration.

The actuator 10a includes at least one elastically bendable coupling element 17 configured to be releasably coupled to the switch 11a.

FIG. 6a shows the fitting 4 according to FIGS. 5a, 5b in a cross-sectional view. The damper housing 9a of the damping device 9 is arranged on an outside of the hinge cup 6a, and the free end of the piston rod 9b is supported on an L-shaped actuator 10a within the interior of the hinge cup 6a. Here, the damping device 9 and the arresting device 11 are arranged on a same side of the hinge cup 6a above each other.

The damping device 9 includes at least one piston 15 displaceable in the damper housing 9a. The piston 15 can have a one-piece configuration or also a multi-piece configuration. A return spring 33 arranged within the damper housing 9a is used to at least partially return the piston rod 9b and the actuator 10.

By a volume compensating device 34, a displaceable volume of the damping fluid can be compensated for when the piston rod 9b is immersed into the damper housing 9a.

The actuator 10a includes an elastically bendable coupling element 17 configured to be releasably coupled to the switch 11a of the arresting device 11. In FIG. 6a, the uncoupled condition between the coupling element 17 and the switch 11a is shown.

For limiting or for deactivating the damping power of the damping device 9, the switch 11a is to be manually moved into a corresponding switching position. Upon the closing movement of the fitting 4, the actuator 10a is displaceable via the other actuator 10 in a plane extending parallel to the bottom 14 of the hinge cup 6a so as to push the piston rod 9b into the damper housing 9a.

FIG. 6b shows a detail view, in which the coupling element 17 of the actuator 10a is arrested by the switch 11a, and a movement of the piston rod 9b in a direction opposite the damping stroke is blocked. Upon a movement of the coupling element 17 in the direction X (FIG. 6a) of the damping stroke, the coupling element 17 can be urged by the switch 11a in a direction towards the bottom 14 of the hinge cup 6a.

Upon a continued movement of the coupling element 17 in the direction X, the coupling element 17 snaps back again, and the switch 11a blocks a movement of the coupling element 17 in a direction opposite the direction X. Due to the piston rod 9b arrested in the retracted position, the damping power of the damping device 9 is limited or deactivated.

By adjusting the switch 11a into a corresponding switching position, the piston rod 9b, the actuator 10a, and the actuator 10 can be again returned by a force of the return spring 33. As an alternative or in addition to a return spring 33, a spring element 20 separate from the return spring 33 can be used.

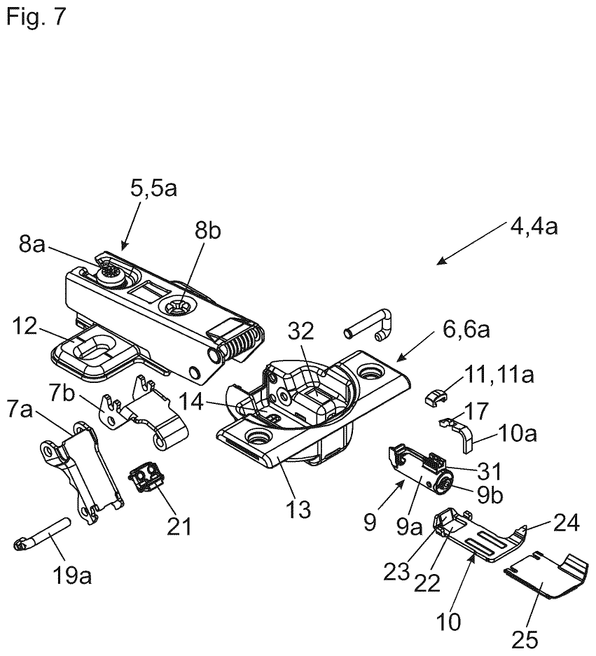

FIG. 7 shows the fitting 4 according to FIGS. 5a, 5b, 6a, 6b in an exploded view. With this embodiment, two actuators 10, 10a are provided. A laterally projecting limb 24 of the actuator 10 bears, preferably loosely, against a portion of the other actuator 10a, the portion of the other actuator 10a extending vertically to the bottom 14 of the hinge cup 6a.

Upon a closing movement of the fitting 4, the actuator 10 is moved along the bottom 14 of the hinge cup 6a by the coupling device 21 of the hinge lever 7a, as already described in connection with the previous embodiment. The limb 24 of the actuator 10 presses against the other actuator 10a, and, in turn, the piston rod 9b can be pushed into the damper housing 9a by the other actuator 10a.

In the shown figure, the piston rod 9b is located in the pressed-in position relative to the damper housing 9a, and the damping power of the damping device 9 is deactivated.

The bearing device 31 for movably supporting the switch 11a and for movably supporting the actuator 10a is connected to the damper housing 9a, preferably so as to have an integral one-piece configuration, and projects through an opening 32 of the hinge cup 6a.

With regard to the other components of the fitting 4, reference is made to the previous embodiment which can be well seen in the exploded view according to FIG. 4.

1. A fitting configured as a furniture fitting or as a construction fitting, the fitting comprising:
at least two fitting portions movable relative to each other,
at least one damping device for dampening a relative movement of the two fitting portions to each other, the damping device being supported on and/or in one of the two fitting portions, the damping device including at least one damper housing, at least one piston displaceable in the damper housing, and a piston rod connected to the piston,
at least one actuator configured to move the piston rod of the damping device into the damper housing when a damping stroke is performed, and
at least one arresting device for limiting or for deactivating a damping power of the damping device, the arresting device being configured to arrest the at least one actuator relative to that fitting portion on which and/or in which the damping device is supported,
wherein at least one of the two fitting portions includes a hinge cup,
wherein the damper housing is arranged on an outside of the hinge cup and below a fastening flange of the hinge cup in a mounted position,
wherein the actuator is linearly displaceably supported on the hinge cup.

2. The fitting according to claim 1, wherein:
the at least one actuator is substantially entirely arranged within the hinge cup, and/or
the at least one actuator is movably-supported relative to the hinge cup, and/or
the at least one actuator is arranged substantially parallel or perpendicular to a bottom of the hinge cup, and/or
the damper housing is entirely arranged outside the hinge cup.

3. The fitting according to claim 1, wherein:
the piston rod partially projects into the hinge cup, and/or
the hinge cup includes a hole for the passage of the piston rod, and/or
the damper housing is arranged on a first side of the hinge cup and the arresting device is arranged on a second side of the hinge cup, the second side of the hinge cup opposing the first side, or that the damper housing and the arresting device are arranged above each other on a same side of the hinge cup, and/or
the arresting device is firmly connected to the hinge cup, preferably via at least one rivet.

4. The fitting according to claim 1, wherein the two fitting portions are pivotally connected to each other via at least one hinge lever, preferably wherein:
the at least one actuator can be pressurized by the at least one hinge lever, and/or
the at least one actuator can be pressurized only upon a closing movement of the at least one hinge lever, and/or
the at least one actuator includes a recess in which the at least one hinge lever or a coupling device connected to the hinge lever engages upon a closing movement of the fitting.

5. The fitting according to claim 1, wherein the two fitting portions are pivotally connected to each other via at least one hinge lever, preferably wherein:
at least one coupling device is provided, the coupling device converting a pivotal movement of the at least one hinge lever into a linear movement of the at least one actuator, and/or
the at least one hinge lever is connected to the first fitting portion via a hinge axis, and is connected to the second fitting portion via a further hinge axis.

6. The fitting according to claim 1, wherein the at least one actuator:
is substantially T-shaped or substantially L-shaped, and/or
includes at least one coupling element configured to be releasably coupled to the arresting device, and/or
is movably arranged on a bearing device connected to the damper housing.

7. The fitting according to claim 1, wherein the at least one actuator:
includes at least one limb configured to bear, preferably loosely, against a free end of the piston rod, and/or
is movable relative to a gliding element, the gliding element being arranged between one of the fitting portions and the actuator so as to reduce friction.

8. The fitting according to claim 1, further comprising at least one spring element, preferably a compression spring, for returning the at least one actuator.

9. The fitting according to claim 1, wherein the arresting device includes at least one switch for limiting or for deactivating a damping power of the damping device, wherein the at least one switch is configured to be releasably coupled to the actuator, preferably wherein the switch and/or the actuator includes or include at least one elastically bendable coupling element.

10. The fitting according to claim 9, wherein the at least one switch:
includes at least two switching positions, wherein the damping power of the damping device is activated in the first switching position, and wherein the damping power of the damping device is limited or deactivated in the second switching position, and/or
is movable in a direction extending transversely, preferably substantially at a right angle, to a longitudinal direction of the piston rod.

11. The fitting according to claim 9, wherein the at least one switch:
includes at least one coupling element configured to be releasably coupled to the actuator, and/or
is configured for manual actuation, and/or
is movably arranged in or on the two fitting portions, preferably on a hinge cup of the fitting, and/or
is movably arranged on a bearing device connected to the damper housing.

12. The fitting according to claim 1, wherein the damping device:
is configured as a linear damper, and/or
includes at least one return spring for returning the piston rod and/or for returning the actuator.

13. The fitting according to claim 1, wherein the fitting is configured as a furniture hinge for movably supporting a furniture part.

14. An item of furniture comprising a furniture carcass, a furniture part movably-supported relative to the furniture carcass, and at least one fitting according to claim 1, wherein a first fitting portion is arranged on the furniture carcass and a second fitting portion is arranged on the movable furniture part, preferably wherein the second fitting portion is partially integrated into the movable furniture part.
